(19) United States
(12) Patent Application Publication
(10) Pub. No.: US 2024/0238718 A1
(43) Pub. Date: Jul. 18, 2024

(54) HEATER ELEMENT AND VEHICLE INTERIOR PURIFICATION SYSTEM

(71) Applicant: NGK INSULATORS, LTD., Nagoya-City (JP)

(72) Inventors: Hirotaka SAITO, Komaki-Shi (JP); Takafumi HAMADA, Nagoya-Shi (JP)

(73) Assignee: NGK INSULATORS, LTD., Nagoya-City (JP)

(21) Appl. No.: 18/508,510

(22) Filed: Nov. 14, 2023

(30) Foreign Application Priority Data
Jan. 17, 2023 (JP) 2023-005439

(51) Int. Cl. B01D 53/04; B01D 53/26; B01D 53/88; B01J 20/06; B01J 20/28; B01J 23/02; B01J 35/00; B01J 35/04; B60H 3/00

(52) U.S. Cl. CPC B01D 53/0438; B01D 53/261; B01D 53/885; B01J 20/06; B01J 20/28011; B01J 20/28045; B01J 23/02; B01J 35/0033; B01J 35/04; B60H 3/0071; B01D 2253/108; B01D 2257/504; B01D 2257/708; B01D 2257/80; B01D 2258/06; B01D 2259/40096; B01D 2259/4566

(57) ABSTRACT

A heater element includes: a honeycomb structure comprising an outer peripheral wall and partition walls disposed on an inner side of the outer peripheral wall, the partition walls defining a plurality of cells, each of the cells extending from a first end face to a second end face to form a flow path, at least the partition walls 14 being made of a material having a PTC property; a pair of electrodes provided on the first end face and the second end face; and terminals provided on at least a part of the pair of electrodes.

### FIELD OF THE INVENTION

The present invention relates to a heater element and a vehicle interior purification system.

### CROSS REFERENCE TO RELATED APPLICATIONS

The present invention claims the benefit of priority to Japanese Patent Application No 2023-005439 filed on Jan. 17, 2023 with the Japanese Patent Office, the entire contents of which are incorporated herein by reference in its entirety.

### BACKGROUND OF THE INVENTION

In various types of vehicles such as automobiles, there are increasing requirements for improvement of vehicle interior environment. Specific requirements include reduction of an amount of CO₂ in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

As a method for solving the above problem, Patent Literatures 1 and 2 disclose a vehicle interior purification system in which components to be removed such as CO₂ and water vapor in the air in the vehicle interior are trapped by a functional material such as an adsorbent, and the components to be removed are then allowed to react or desorbed by heating to discharge them to the outside of the vehicle and regenerate the functional material. Such a vehicle interior purification system requires more contact between the air and the functional material in order to ensure the performance of trapping the components to be removed, and the ability of the functional material to be heated to a predetermined temperature in order to facilitate the regeneration of the functional material. The regeneration can be carried out, for example, by removing substances adsorbed on the functional material through an oxidation reaction, and by desorbing and releasing the substances adsorbed on the functional material, but both cases require the heating of the functional material at an appropriate temperature depending on the adsorbed substances.

On the other hand, Patent Literature 3 discloses a heater element, including: a pillar shaped honeycomb structure having an outer peripheral wall and partition walls disposed on an inner side of the outer peripheral wall and defining a plurality of cells forming flow paths from a first end face to a second end face, wherein the partition walls have a PTC property, the partition walls have an average thickness of 0.13 mm or less, and the first end face and the second end face have an opening ratio of 0.81 or more. This heater element is used for heating a vehicle interior, and is an efficient heating means because the honeycomb structure allows the heating area to be increased. Therefore, the use of such a heater element as a support for the functional material can contribute to the shortening of the regeneration time of the functional material. In particular, it is believed that since this heater element can be heated by electric conduction and has a PTC property, it can easily heat the functional material, while suppressing excessive heat generation and thermal deterioration of the functional material. Further, since the risk of excessive temperature is avoided, safety can be ensured even if small initial resistance is set to increase a heating rate, and the temperature can be increased in a short period of time.

However, the heater element described in Patent Literature 3 may cause deviation of current during heating by electric conduction. Such deviation of current causes non-uniform temperature distribution within the heater element. In the heater element supporting a functional material, the performance of the functional material is not sufficiently exerted at a lower temperature portion of the heater element. Also, if an amount of electric conduction is increased in order to sufficiently exert the performance of the functional material, any local excessive heat generation cannot be sufficiently suppressed even if the heater element has a PTC property, so that the functional material may be deteriorated and a honeycomb structure making up the heating element may be damaged.

The present invention was made to solve the problems as described above. An object of the present invention is to provide a heater element that can sufficiently exert the performance of a functional material, and suppress deterioration of the functional material and damage to a honeycomb structure.

Also, another object of the present invention is to provide a vehicle interior purification system including such a heater element.

### PRIOR ART

### Patent Literatures

[Patent Literature 1] Japanese Patent Application Publication No. 2020-104774 A
[Patent Literature 2] Japanese Patent Application Publication No. 2020-111282 A
[Patent Literature 3] WO 2020/036067 A1

### SUMMARY OF THE INVENTION

As a result of extensive studies, the present inventors have found that the above problems can be solved by controlling volume resistivities and thicknesses of partition walls making up a honeycomb structure, a pair of electrodes and terminals so as to satisfy a predetermined relationship, in a heater element including the honeycomb structure, the pair of electrodes provided on both end faces of the honeycomb structure, and the terminals provided on at least a part of the pair of electrodes, and they have completed the present invention. That is, the present invention is illustrated as follows:

(1)

A heater element, comprising:
a honeycomb structure comprising an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property;
a pair of electrodes provided on the first end face and the second end face; and
terminals provided on at least a part of the pair of electrodes,
wherein (ρ1/t1)/(ρ2/t2) is 0.003 or less, and (ρ1/t1)/(ρ3/t3) is 0.02 or more, wherein ρ1 is a volume resistivity [Ω·cm] of the pair of electrodes, t1 is a thickness [mm] of the pair of electrodes, ρ2 is a volume resistivity [Ω·cm] of the partition walls, t2 is a thickness of the partition wall [mm], ρ3 is a volume resistivity [Ω·cm] of the terminals, and t3 is a thickness [mm] of the terminal.
   (2)

The heater element according to (1), wherein S1/S2 is 0.010 or more, wherein S1 is an area [mm²] of surfaces where the terminals are in contact with the pair of electrodes, and S2 is an area [mm²] of the first end face or the second end face of the honeycomb structure.

(3)

The heater element according to (2), wherein the S1/S2 is 0.010 to 0.430.

(4)

The heater element according to any one of (1) to (3), further comprising an intermediate material between the pair of electrodes and the terminals, wherein S4/S3 is 0.50 to 2.00, wherein S3 is an area [mm²] of surfaces where the terminals are in contact with the intermediate material, and S4 is an area [mm²] of a surface where the intermediate material is in contact with the pair of electrodes.

(5)

The heater element according to any one of (1) to (4), wherein the material having the PTC property is made of a material comprising barium titanate as a main component, the material being substantially free of lead.

(6)

The heater element according to any one of (1) to (5), wherein the material having the PTC property has a volume resistivity of 0.5 to 30 Ω·cm at 25° C.

(7)

The heater element according to any one of (1) to (6), wherein the honeycomb structure has a thickness of the partition wall of 0.300 mm or less, a cell density of 100 cells/cm² or less, and a cell pitch of 1.0 mm or more.

(8)

The heater element according to any one of (1) to (6), wherein the honeycomb structure has a thickness of the partition wall of 0.08 to 0.36 mm, a cell density of 2.54 to 140 cells/cm², and an opening ratio of the cells of 0.70 or more.

(9)

The heater element according to any one of (1) to (8), comprising a functional material-containing layer on surfaces of the partition walls.

(10)

The heater element according to (9), wherein the functional material-containing layer comprises a functional material having a function of adsorbing one or more selected from water vapor, carbon dioxide, and volatile components.

(11)

The heater element according to (9) to (10), wherein the functional material-containing layer comprises a catalyst.

(12)

A vehicle interior purification system, comprising:
at least one heater element according to any one of (1) to (11);
a power supply for applying a voltage to the heater element;
an inflow pipe communicating a vehicle interior with the first end face of the heater element;
an outflow pipe having a first path communicating the second end face of the heater element with the vehicle interior; and
a ventilator for causing an air from the vehicle interior to flow into the first end face of the heater element through the inflow pipe.
   (14)

The vehicle interior purification system according to (12),
wherein the outflow pipe has, in addition to the first path, a second path communicating the second end face of the heater element with the outside of a vehicle,
wherein the outflow pipe has a switching valve capable of switching the flow of the air flowing through the outflow pipe between the first path and the second path, and
wherein the vehicle interior purification system comprises a control unit capable of executing switching between:
   a first mode wherein the voltage applied from the power supply is turned off, the switching valve is switched such that the air flowing through the outflow pipe passes through the first path, and the ventilator is turned on; and
   a second mode wherein the voltage applied from the power supply is turned on, the switching valve is switched such that the air flowing through the outflow pipe passes through the second path, and the ventilator is turned on.

### BRIEF DESCRIPTION OF THE DRAWINGS

FIG. 1A is a schematic view of a cross section of a heater element according to an embodiment of the invention, which is parallel to an extending direction of cells (flow path);

FIG. 1B is a schematic cross-sectional view taken along the line a-a′ in FIG. 1A;

FIG. 1C is a schematic cross-sectional view taken along the line b-b′ in FIG. 1A;

FIG. 2A is a schematic view of a cross section of a heater element according to another embodiment of the present invention, which is orthogonal to a flow path direction;

FIG. 2B is a schematic cross-sectional view taken along the line a-a′ in FIG. 2A;

FIG. 2C is a schematic cross-sectional view taken along the line b-b′ in FIG. 2A;

FIG. 3 is a schematic view of a cross section of a heater element according to another embodiment of the present invention, which is parallel to an extending direction of cells (flow path);

FIG. 4 is a schematic view of a cross section according to another embodiment of the present invention, which is orthogonal to a flow path direction of a heater element; and

FIG. 5 is a schematic view illustrating a structure of a vehicle interior purification system according to an embodiment of the present invention.

### DETAILED DESCRIPTION OF THE INVENTION

A heater element according to an embodiment of the present invention includes: a honeycomb structure having an outer peripheral wall and partition walls disposed on an inner side of the outer peripheral wall, the partition walls defining a plurality of cells, each of the cells extending from a first end face to a second end face to form a flow path, at least the partition walls being made of a material having a PTC (Positive Temperature Coefficient) property; a pair of electrodes provided on the first end face and the second end face; and terminals provided on at least a part of the pair of electrodes, wherein (ρ1/t1)/(ρ2/t2) is 0.003 or less, and (ρ1/t1)/(ρ3/t3) is 0.02 or more, wherein ρ1 is a volume resistivity [Ω·cm] of the pair of electrodes, t1 is a thickness [mm] of the pair of electrodes, ρ2 is a volume resistivity [Ω·cm] of the partition walls, t2 is a thickness of the partition wall [mm], ρ3 is a volume resistivity [Ω·cm] of the terminals, and t3 is a thickness [mm] of the terminal. Such a configuration can suppress the deviation of the current when heating the heater element by electric conduction, so that a temperature distribution in the heater element can be made uniform. Therefore, the interior of the heater element can be uniformly heated by electric conduction, and the performance of the functional material can be sufficiently exerted. Also, it is difficult to generate any local excessive heat generation of the heater element, so that deterioration of the functional material and damage to the honeycomb structure can also be suppressed.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

### (1. Heater Element)

The heater element according to an embodiment of the present invention can be suitably utilized as a heater element for use in a vehicle interior purification system for various vehicles such as automobiles. The vehicle includes, but not limited to, automobiles and trains. Non-limiting examples of the automobile include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The heater element according to the embodiment of the present invention can be particularly suitably used for a vehicle having no internal combustion engine such as electric vehicles and electric railcars.

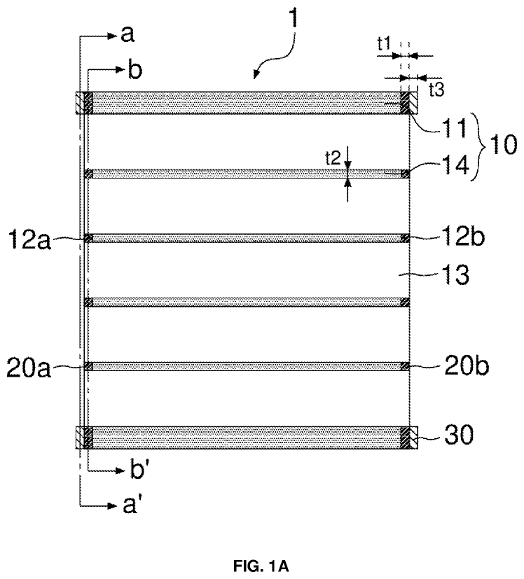

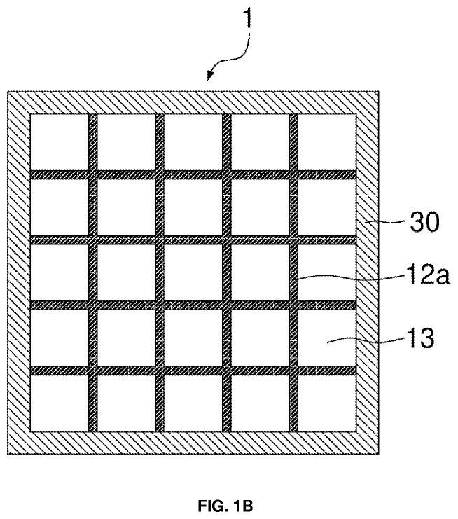

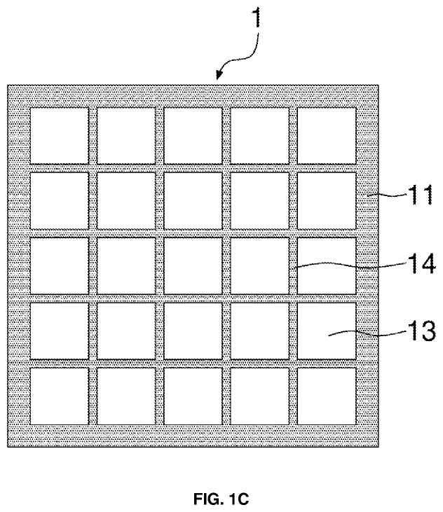

FIG. 1A is a schematic view of a cross section of a heater element according to an embodiment of the invention, which is parallel to an extending direction of cells (flow path). Further, FIG. 1B is a schematic cross-sectional view taken along the line a-a′ in FIG. 1A, and FIG. 1C is a schematic cross-sectional view taken along the line b-b′ in FIG. 1A.

As shown in FIGS. 1A and 1B, a heater element 1 includes: a honeycomb structure 10 having an outer peripheral wall 11 and partition walls 14 disposed on an inner side of the outer peripheral wall 11 and defining a plurality of cells 13 to form flow paths extending from a first end face 12a to a second end face 12b; a pair of electrodes 20a, 20b provided on the first end face 12a and the second end face 12b; and terminals 30 provided on at least a part of the pair of electrodes 20a, 20b.

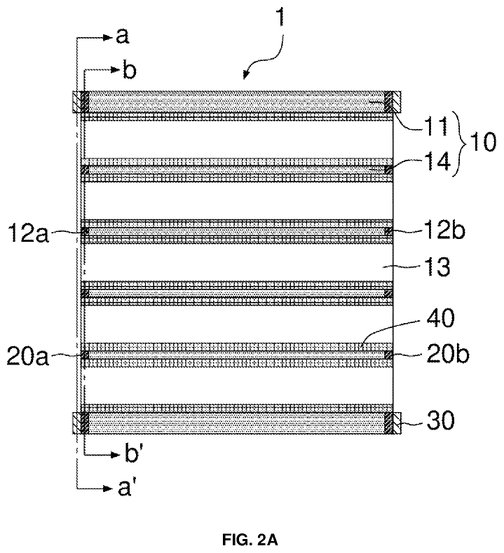

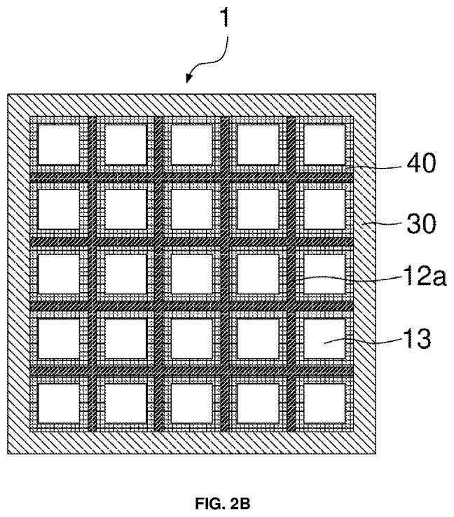

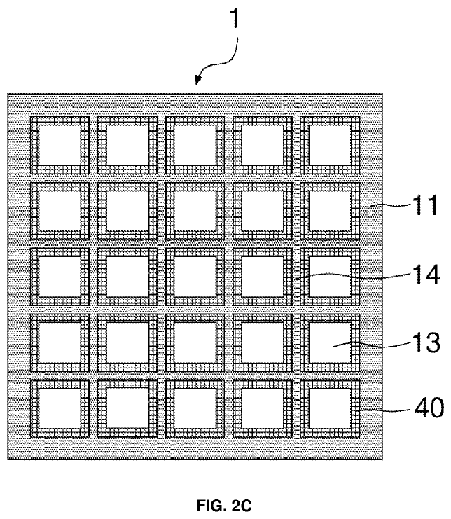

The heater element 1 can be used as a support (carrier) for forming a functional material-containing layer. FIG. 2A shows a schematic view of a cross section with the functional material-containing layer formed on the heater element, which is parallel to the extending direction of the cells (flow path), FIG. 2B shows a schematic view of a cross section taken along the line a-a′ in FIG. 2A, and FIG. 2C shows a schematic view of the cross section taken along the line b-b′ in FIG. 2A. FIGS. 2A to 2C have the same configurations as those of FIGS. 1A to 1C with the exception that the functional material-containing layer is formed.

As shown in FIGS. 2A to 2C, the heater element 1 includes a functional material-containing layer 40 provided on the surfaces of the partition walls 14.

In the heater element 1, the volume resistivity [cm] of the pair of electrodes 20a, 20b is ρ1, the thickness [mm] of the pair of electrodes 20a, 20b is t1, the volume resistivity [cm] of the partition walls 14 is ρ2, the thickness [mm] of the partition wall 14 is t2, the volume resistivity [Ω·cm] of the terminals 30 is ρ3, and the thickness [mm] of the terminal 30 is t3.

In this case, in the heater element 1, (ρ1/t1)/(ρ2/t2) is 0.003 or less. By controlling the value of (ρ1/t1)/(ρ2/t2) in such a range, the electrical resistance of the pair of electrodes 20a, 20b is sufficiently lower than that of the base material (partition walls 14) of the heater element. As a result, the current from the pair of electrodes 20a, 20b tends to spread uniformly to the partition walls 14, so that the deviation of the current can be suppressed and the temperature distribution in the heater element 1 can be made uniform. From the viewpoint of stably ensuring this effect, the (ρ1/t1)/(ρ2/t2) is preferably 0.001 or less, and more preferably 0.0001 or less. Although the lower limit is not particularly limited because a lower value of (ρ1/t1)/(ρ2/t2) tends to obtain the above effect, it is, for example, 0.0000001.

Further, in the heater element 1, the (ρ1/t1)/(ρ3/t3) is 0.02 or more. By controlling the value of (ρ1/t1)/(ρ3/t3) in such a range, the current from the terminals 30 tends to spread uniformly to the pair of electrodes 20a, 20b. As a result, the current also tends to spread uniformly from the pair of electrodes 20a, 20b to the partition walls 14, so that the deviation of the current can be suppressed and the temperature distribution in the heater element 1 can be made uniform. It should be noted that if the (ρ1/t1)/(ρ3/t3) is less than 0.02, the current will flow through a part of the pair of electrodes 20a, 20b before spreading the current in the terminals, resulting in the deviation of the current. From the viewpoint of stably ensuring the above effects, the (ρ1/t1)/(ρ3/t3) is preferably 1 or more, and more preferably 10 or more. Although the upper limit is not particularly limited because a larger value of (ρ1/t1)/(ρ3/t3) tends to obtain the above effect, it is, for example, 5000.

As used herein, the thickness of the pair of electrodes 20a, 20b refers to an average value of the thicknesses of all the electrodes 20a, 20b. Further, the thickness of the partition wall 14 refers to a length of a line segment that is a crosse the partition wall 14 when the centers of gravity of adjacent cells 13 are connected by the line segment in a cross section orthogonal to the flow path direction. The thickness of the partition wall 14 refers to an average value of the thicknesses of all the partition walls 14. Furthermore, the thickness of the terminal 30 refers to an average value of the thicknesses of all the terminals 30.

The thicknesses of the pair of electrodes 20a, 20b and the terminal 30 can be measured in the cross section parallel to the flow path direction. Alternatively, the thicknesses of the materials used for the pair of electrodes 20a, 20b and the terminals 30 may be the thicknesses of the pair of electrodes 20a, 20b and the terminal 30. Also, the thickness of the partition wall 14 can be measured in the cross section orthogonal to the flow path direction.

The volume resistivity of each of the pair of electrodes 20a, 20b, the partition walls 14, and the terminals 30 refers to a volume resistivity at 25° C. The volume resistivity at 25° C. is measured according to JIS K 6271: 2008.

In the heater element 1, the area [mm²] of the surfaces where the terminals 30 are in contact with the pair of electrodes 20a, 20b is S1, and the area [mm²] of the first end face 12a or second end face 12b of the honeycomb structure 10 is S2.

In this case, it is preferable that the heater element 1 has S1/S2 of 0.010 or more. By controlling the value of S1/S2 in such a range, it is possible to increase the area of the region where the current flows from the terminals 30 to the honeycomb structure 10 (electric conduction area), thereby suppressing the deviation of the current and easily making the temperature distribution in the element 1 uniform. From the viewpoint of stably ensuring this effect, the S1/S2 is more preferably 0.050 or more, and even more preferably 0.150 or more. On the other hand, a lager S1/S2 results in a smaller area of the region (cells 13) through which the air flows. Therefore, the S1/S2 is preferably 0.430 or less, and more preferably 0.300 or less, and even more preferably 0.250 or less.

As used herein, the area of the first end face 12a or the second end face 12b of the honeycomb structure 10 refers to an area of the first end face 12a or the second end face 12b composed of the outer peripheral wall 11, the cells 13, and the partition walls 14.

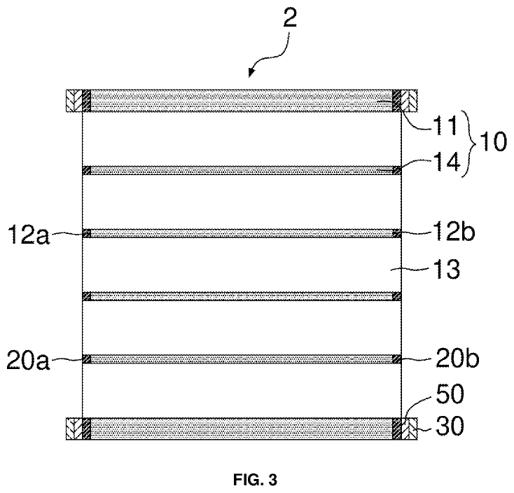

The heater element according to the embodiment of the present invention can further include an intermediate material between the pair of electrodes 20a, 20b and the terminals 30, if necessary. FIG. 3 shows a schematic view of a cross section of the heater element according to such an embodiment, which is parallel to the extending direction of the cells (flow path).

As shown in FIG. 3, a heater element 2 further includes an intermediate member 50 between the pair of electrodes 20a, 20b and the terminals 30.

In the heater element 2, the area [mm²] of the surfaces where the terminals 30 are in contact with the intermediate material 50 is S3, and the area [mm²] of the surface where the intermediate material 50 is contact with the pair of electrodes 20a, 20b is S4.

In this case, the heater element 2 preferably has S4/S3 of 0.50 to 2.00. By controlling the value of S4/S3 in such a range, it is possible to smooth the flow of current between the pair of electrodes 20a, 20b and the terminals 30, thereby suppressing the deviation of the current and easily making the temperature distribution in the heater element 2 uniform. Also, when the S4/S3 is larger than 2.00, the above effect (effect of suppressing the local heat generation due to the deviation of the power) can be obtained, while the flow of the air is obstructed by the intermediate material 50, so that the contact area of the functional material with the air decreases, making it difficult to obtain sufficient performance of the functional material. Further, when the S4/S3 is less than 0.50, it is difficult to obtain the above effect (the effect of suppressing the local heat generation due to the deviation of the power). From the viewpoint of stably ensuring the above effects, the S4/S3 is more preferably 0.50 to 1.20, and still more preferably 0.80 to 1.20. Each member forming the heater element 1 will be described below in detail.

### (1-1. Honeycomb Structure)

The shape of the honeycomb structure 10 is not particularly limited. For example, an outer shape of a cross section of the honeycomb structure 10 orthogonal to the flow path direction (the extending direction of the cells 13) can be polygonal such as quadrangular (rectangular, square), pentagonal, hexagonal, heptagonal, and octagonal, circular, oval (egg-shaped, elliptical, elliptic, rounded rectangular, etc.), or the like. The end faces (first end face 12a and second end face 12b) have the same shape as the cross section. Also, when the cross section and the end faces are polygonal, the corners may be chamfered.

The shape of each cell 13 is not particularly limited, but it may be polygonal such as quadrangular, pentagonal, hexagonal, heptagonal, and octagonal, circular, or oval in the cross section of the honeycomb structure 10 orthogonal to the flow path direction. These shapes may be alone or in combination of two or more. Moreover, among these shapes, the quadrangle or the hexagon is preferable. By providing the cells 13 having such a shape, it is possible to reduce the pressure loss when the air flows. FIGS. 1A to 1C and FIGS. 2A to 2C show, as an example, a honeycomb structure 10 in which the outer shape of the cross section and the shape of each cell 13 are quadrangular in the cross section orthogonal to the flow path direction.

The honeycomb structure 10 may be a honeycomb joined body having a plurality of honeycomb segments and joining layers that join outer peripheral side surfaces of the plurality of honeycomb segments together. The use of the honeycomb joined body can increase the total cross-sectional area of the cells 13, which is important for ensuring the flow rate of air, while suppressing cracking.

It should be noted that the joining layer can be formed by using a joining material. The joining material is not particularly limited, but a ceramic material obtained by adding a solvent such as water to form a paste can be used. The joining material may contain a material having the PTC property, or may contain the same material as the outer peripheral wall 11 and the partition walls 14. In addition to the role of joining the honeycomb segments to each other, the joining material can also be used as an outer peripheral coating material after joining the honeycomb segments.

From the viewpoints of ensuring the strength of the honeycomb structure 10, reducing pressure loss when air passes through the cells 13, ensuring the amount of functional material supported, and ensuring the contact area with the air flowing inside the cells 13, it is desirable to suitably combine a thickness of the partition wall 14, a cell density, and a cell pitch (or an opening ratio of the cells).

As used herein, the cell density refers a value obtained by dividing a number of cells by an area of one end face (first end face 12a or second end face 12b) of the honeycomb structure 10 (the total area of the partition walls 14 and the cells 13 excluding the outer peripheral wall 11).

As used herein, the cell pitch refers to a value obtained by the following calculation. First, the area of one end face (first end face 12a or second end face 12b) of the honeycomb structure 10 (the total area of the partition walls 14 and the cells 13 excluding the outer peripheral wall 11) is divided by the number of the cells to calculate an area per a cell. A square root of the area per a cell is then calculated, and this is determined to be the cell pitch.

As used herein, the opening ratio of the cells 13 refers a value obtained by dividing the total area of the cells 13 defined by the partition walls 14 by the area of one end face 12b (first end face 12a or second end face 12b) (the total area of the partition walls 14 and the cells 13 excluding the outer peripheral wall 11) in the cross section orthogonal to the flow path direction of the honeycomb structure 10. It should be noted that when calculating the opening ratio of the cells 13, the pair of electrodes 20a, 20b, and the functional material-containing layer 40 are not taken into account.

In an embodiment that is advantageous from the viewpoint of supporting a sufficient amount of functional material, the thickness of the partition wall 14 is 0.300 mm or less, the cell density is 100 cells/cm² or less, and the cell pitch is 1.0 mm or more. In a preferred embodiment, the thickness of the partition wall 14 is 0.200 mm or less, the cell density is 70 cells/cm² or less, and the cell pitch is 1.2 mm or more. In a more preferred embodiment, the thickness of the partition wall is 0.130 mm or less, the cell density is 65 cells/cm² or less, and the cell pitch is 1.3 mm or more.

In each of the above embodiments, from the viewpoints of ensuring the strength of the honeycomb structure 10 and maintaining lower electrical resistance, the lower limit of the thickness of the partition wall 14 is preferably 0.010 mm or more, and more preferably 0.020 mm or more, and even more preferably 0.030 mm or more.

In each of the above embodiments, from the viewpoints of ensuring the strength of the honeycomb structure 10, maintaining lower electrical resistance, and increasing a surface area to facilitate reaction, adsorption, and release, the lower limit of the cell density is 30 cells/cm² or more, and preferably 35 cells/cm² or more, and even more preferably 40 cells/cm² or more.

In each of the above embodiments, from the viewpoints of ensuring the strength of the honeycomb structure 10, maintaining lower electrical resistance and increasing a surface area to facilitate reaction, adsorption and release, the upper limit of the cell pitch is 2.0 mm or less, and more preferably 1.8 mm or less, and even more preferably 1.6 mm or less.

In an embodiment that is advantageous in terms of both reducing pressure loss and maintaining strength, the thickness of the partition wall 14 is 0.08 to 0.36 mm, the cell density is 2.54 to 140 cells/cm², and the opening ratio of the cells 13 is 0.70 or more. In a preferred embodiment, the thickness of the partition wall 14 is 0.09 to 0.35 mm, the cell density is 15 to 100 cells/cm², and the opening ratio of the cells 13 is 0.80 or more. In a more preferred embodiment, the thickness of the partition wall 14 is 0.14 to 0.30 mm, the cell density is 20 to 90 cells/cm², and the opening ratio of the cells 13 is 0.85 or more.

In each of the above embodiments, from the viewpoint of ensuring the strength of the honeycomb structure 10, the upper limit of the opening ratio of the cells 13 is preferably 0.94 or less, and more preferably 0.92 or less, and even more preferably 0.90 or less.

Although the thickness of the outer peripheral wall 11 is not particularly limited, it is preferably determined based on the following viewpoints. First, from the viewpoint of reinforcing the honeycomb structure 10, the thickness of the outer peripheral wall 11 is preferably 0.05 mm or more, and more preferably 0.06 mm or more, and even more preferably 0.08 mm or more. On the other hand, the thickness of the outer peripheral wall 11 is preferably 1.0 mm or less, and more preferably 0.5 mm, and more preferably 0.4 mm or less, and still more preferably 0.3 mm or less, from the viewpoint of suppressing the initial current by increasing the electrical resistance and from the viewpoint of reducing pressure loss when air flows.

As used herein, the thickness of the outer peripheral wall 11 refers to a length from a boundary between the outer peripheral wall 11 and the outermost cell 13 or the partition wall 14 to a side surface of the honeycomb structure 10 in a normal line direction of the side surface in the cross section orthogonal to the flow path direction.

The length of the honeycomb structure 10 in the flow path direction and the cross-sectional area orthogonal to the flow path direction may be adjusted according to the required size of the heater element 1, 2, and are not particularly limited. For example, when used in a compact heater element 1, 2 while ensuring a predetermined function, the honeycomb structure 10 can have a length of 2 to 20 mm in the flow path direction and a cross-sectional area of 10 cm² or more orthogonal to the flow path direction. Although the upper limit of the cross-sectional area orthogonal to the flow path direction is not particularly limited, it is, for example, 300 cm².

The partition walls 14 forming the honeycomb structure 10 are made of a material that can be heated by electric conduction, specifically made of a material having the PTC property. Further, the outer peripheral wall 11 may also be made of the material having the PTC property, as with the partition walls 14, as needed. By such a configuration, the functional material-containing layer 40 can be heated by heat transfer from the heat-generating partition walls 14 (and optionally the outer peripheral wall 11). Further, the material having the PTC property has characteristics such that when the temperature increases to exceed the Curie point, the resistance value is sharply increased, resulting in a difficult for electricity to flow. Therefore, when the temperature of the heater element 1, 2 becomes high, the partition walls 14 (and the outer peripheral wall 11 if necessary) limit the current flowing through them, thereby suppressing excessive heat generation of the heater element 1, 2. Therefore, it is possible to suppress thermal deterioration of the functional material-containing layer 40 due to excessive heat generation.

The lower limit of the volume resistivity at 25° C. of the material having the PTC property is preferably 0.5 Ω·cm or more, and more preferably 1 Ω·cm or more, and even more preferably 5 Ω·cm or more, from the viewpoint of obtaining appropriate heat generation. The upper limit of the volume resistivity at 25° C. of the material having the PTC property is preferably 30 Ω·cm or less, and more preferably 18 Ω·cm or less, and even more preferably 16 Ω·cm or less, from the viewpoint of generating heat with a low driving voltage. As used herein, the volume resistivity at 25° C. of the material having the PTC property is measured according to JIS K 6271: 2008.

From the viewpoints that can be heated by electric conduction and has the PTC property, the outer peripheral wall 11 and the partition walls 14 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can also be measured by the same method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

The content of the BaTiO₃-based crystalline particles can be measured by fluorescent X-ray analysis. Other crystalline particles can be measured in the same manner as this method.

In terms of reduction of the environmental load, it is desirable that the materials used for the outer peripheral wall 11 and the partition walls 14 are substantially free of lead (Pb). More particularly, the outer peripheral wall 11 and the partition walls 14 preferably have a Pb content of 0.01% by mass or less, and more preferably 0.001% by mass or less, and still more preferably 0% by mass. The lower Pb content can allow the air heated by contact with the heat-generating partition walls 14 to be safely applied to organisms such as humans, for example. In the outer peripheral wall 11 and the partition walls 14, the Pb content is preferably less than 0.03% by mass, and more preferably less than 0.01% by mass, and further preferably 0% by mass, as converted to PbO. The lead content can be determined by ICP-MS (inductively coupled plasma mass spectrometry).

The material making up the outer peripheral wall 11 and the partition walls 14 preferably have a lower limit of a Curie point of 100° C. or more, and more preferably 110° C. or more, and even more preferably 125° C. or more, in terms of efficiently heating the air. Further, the upper limit of the Curie point is preferably 250° C. or more, and preferably 225° C. or more, and even more preferably 200° C. or more, and still more preferably 150° C. or more, in terms of safety as a component placed in the vehicle interior or near the vehicle interior.

The Curie point of the material making up the outer peripheral wall 11 and the partition walls 14 can be adjusted by the type of shifter and an amount of the shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20° C.) is defined as the Curie point.

### (1-2. A Pair of Electrodes)

A pair of electrodes 20a, 20b are provided on the first end face 12a and the second end face 12b.

Applying of a voltage between the pair of electrodes 20a, 20b allows the honeycomb structure 10 to generate heat by Joule heat.

The pair of electrodes 20a, 20b may employ, for example, a metal or alloy containing at least one selected from Cu, Ag, Al, Ni and Si, although not particularly limited thereto. It is also possible to use an ohmic electrode capable of ohmic contact with the outer peripheral wall 11 and/or the partition walls 14 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 20a, 20b may have a single-layer structure, or may have a laminated structure of two or more layers. When the pair of electrodes 20a, 20b have the laminated structure of two or more layers, the materials of the respective layers may be of the same type or of different types.

The thickness of the pair of electrodes 20a, 20b may be appropriately set according to the method for forming the pair of electrodes 20a, 20b. The method for forming the pair of electrodes 20a, 20b includes metal deposition methods such as sputtering, vapor deposition, electrolytic deposition, and chemical deposition. Alternatively, the pair of electrodes 20a, 20b can be formed by applying an electrode paste and then baking it, or by thermal spraying. Furthermore, the pair of electrodes 20a, 20b may be formed by joining metal sheets or alloy sheets.

Each of the thicknesses of the pair of electrodes 20a, 20b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each of the thicknesses is preferably about 5 to 100 μm.

### (1-3. Terminal)

The terminals 30 are provided on at least a part of the pair of electrodes 20a, 20b. The provision of the terminals 30 facilitates connection to an external power supply. The terminals 30 are connected to a conductor connected to the external power supply.

The terminals 30 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

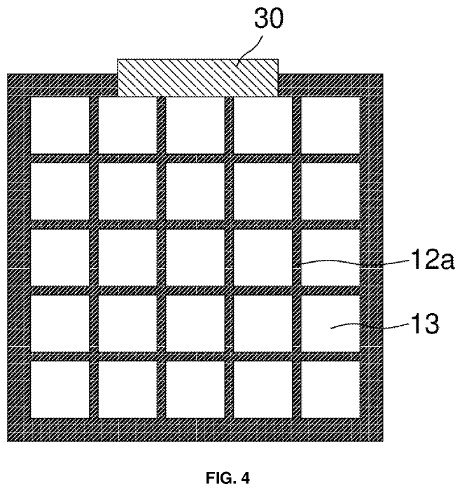

The size and shape of the terminal 30 are not particularly limited. For example, as shown in FIGS. 1A and 1B, the terminals 30 can be provided on the whole of the pair of electrodes 20a, 20b on the outer peripheral wall 11. Further, as shown in FIG. 4, the terminals 30 may be provided on a part of the pair of electrodes 20a, 20b on the outer peripheral wall 11, or may be provided so as to extend toward an outer side than the outer edge of each of the pair of electrodes 20a, 20b on the outer peripheral wall 11. Further, although not shown, the terminals 30 may be provided on a part of the pair of electrodes 20a, 20b on the partition walls 14, or may be provided so as to block a part of the cells 13.

Furthermore, the thickness of the terminal 30 is not particularly limited, but it is, for example, 0.01 to 10 mm, typically 0.05 to 5 mm.

The method of connecting the terminals 30 to the pair of electrodes 20a, 20b is not particularly limited as long as they are electrically connected. For example, they can be connected by diffusion bonding, a mechanical pressing mechanism, welding, or the like.

### (1-4. Intermediate Material)

The intermediate material 50 is provided between the pair of electrodes 20a, 20b and the terminals 30. By providing the intermediate material 50, a degree of structural freedom in the connection between the pair of electrodes 20a, 20b and the terminals 30 is increased.

The intermediate material 50 may be made of non-limiting materials, and it may be the same as the material of the terminal 30 as described above. Moreover, the material of the intermediate material 50 may be different from that of the terminal 30 as described above. In this case, the intermediate material 50 can be made of a solder, a brazing material, a conductive adhesive, or the like.

The size and shape of the intermediate member 50 are not particularly limited. For example, as shown in FIG. 3, the intermediate material 50 can be provided over the whole of the pair of electrodes 20a, 20b on the outer peripheral wall 11. Further, although not shown, the intermediate material 50 may be provided on a part of the pair of electrodes 20a, 20b on the outer peripheral wall 11, or may be provided so as to extend toward an outer side than the outer edge of each of the pair of electrodes 20a, 20b on the outer peripheral wall 11. Furthermore, although not shown, the intermediate material 50 may be provided on a part of the pair of electrodes 20a, 20b on the partition walls 14, or may be provided so as to block a part of the cells 13.

The thickness of the intermediate member 50 is not particularly limited, and it may be approximately the same as the thickness of the terminal 30, for example.

The method of connecting the intermediate member 50 to the terminals 30 and the pair of electrodes 20a, 20b is not particularly limited as long as they are electrically connected, and they may be connected by, for example, diffusion bonding, mechanical pressing mechanism, welding, or the like.

### (1-5. Functional Material-Containing Layer)

The functional material-containing layer 40 can be provided on the surfaces of the partition walls 14 (in the case of the outermost cells 13, the partition walls 14 that define the outermost cells 13 and the outer peripheral wall 11). By thus providing the functional material-containing layer 40, the functional material can be easily heated, so that the functional material can exert its desired function.

The functional material contained in the functional material-containing layer 40 is not particularly limited as long as it is a material that can exhibit a desired function, and examples that can be used herein include adsorbents, catalysts, and the like. The adsorbent preferably has a function of adsorbing one or more components selected from components to be removed in the air, such as water vapor, carbon dioxide, and volatile components. Also, the use of the catalyst can purify the components to be removed. Furthermore, the adsorbent and the catalyst may be used together for the purpose of enhancing the function of the absorbent to capture the components to be removed.

The adsorbent preferably has a function that can adsorb the components to be removed, such as water vapor, carbon dioxide and volatile components at −20 to 40° C. and release them at an elevated temperature of 60° C. or more. Examples of the adsorbent having such functions include zeolite, silica gel, activated carbon, alumina, silica, low-crystalline clay, amorphous aluminum silicate complexes, and the like. The type of the adsorbent may be appropriately selected depending on the types of the components to be removed. The adsorbent may be used alone, or in combination with two or more types.

The catalyst preferably has a function capable of promoting the oxidation-reduction reaction. The catalysts having such functions include metal catalysts such as Pt, Pd and Ag, and oxide catalysts such as CeO₂ and ZrO₂. The catalyst may be used alone, or in combination with two or more types.

The volatile components contained in the air in the vehicle interior include, for example, volatile organic compounds (VOCs), and odor components other than the VOCs Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The thickness of the functional material-containing layer 40 may be determined according to the size of the cells 13, and is not particularly limited. For example, the thickness of the functional material-containing layer 40 is preferably 20 μm or more, and more preferably 25 μm or more, and even more preferably 30 μm or more, from the viewpoint of ensuring sufficient contact with air. On the other hand, the thickness of the functional material-containing layer 40 is preferably 400 μm or less, and more preferably 380 μm or less, and even more preferably 350 μm or less, from the viewpoint of suppressing separation of the functional material-containing layer 20 from the partition walls 14 and the outer peripheral wall 11.

The thickness of the functional material-containing layer 40 is measured using the following procedure. Any cross section parallel to the flow path direction of the honeycomb structure 10 is cut out, and a cross-sectional image at magnifications of about 50 is acquired using a scanning electron microscope or the like. Also, this cross section is made to pass through the center of gravity position in the cross section orthogonal to the flow path of the honeycomb structure 10. The thickness of each functional material-containing layer 40 visually recognized from the cross-sectional image is calculated by dividing the cross-sectional area by the length of the cells 13 in the flow path direction. This calculation is performed for all the functional material-containing layers 40 visually recognized from the cross-sectional image, and an average value thereof is determined to be the thickness of the functional material-containing layer 40.

From the viewpoint that the functional material exhibits a desired function in the heater element 1, 2, an amount of the functional material-containing layer 40 is preferably 50 to 500 g/L, and more preferably 100 to 400 g/L, and even more preferably 150 to 350 g/L, based on the volume of the honeycomb structure 10. It should be noted that the volume of the honeycomb structure 10 is a value determined by the external dimensions of the honeycomb structure 10.

### (2. Method for Producing Heater Element)

The method for producing the heater element according to the embodiment of the present invention is not particularly limited as long as it is the method having the above features, and it can be performed according to a known method. Hereinafter, the method for producing the heater element according to an embodiment of the present invention will be illustratively described.

A method for producing the honeycomb structure forming the heater element includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extrude the green body. In the extrusion, a die having a desired overall shape, cell shape, partition wall thickness, cell density and the like can be used.

The relative density of the honeycomb formed body obtained by extrusion is 60% or more, and preferably 65% or more. By controlling the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 10 containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure 10 can be densified.

Further, the heating rate of 20 to 600° C./hour from the temperature of 1150 to 1250° C. to the maximum temperature of 1360 to 1430° ° C. can allow 1.0 to 10.0% by mass of Ba₆Ti₁₇O₄₀ crystal particles to be formed in the honeycomb structure 10.

The maintaining time at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining at 900 to 950° C. for 0.5 to 5 hours during the increasing of the temperature. The maintaining at 900 to 950° C. for 0.5 to 5 hours can lead to sufficient decomposition of BaCO₃, so that the honeycomb structure 10 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

By forming a pair of electrodes 20a, 20b on the honeycomb structure 10 thus obtained, the heater element 1, 2 can be produced. The pair of electrodes 20a, 20b can also be formed by metal deposition methods such as sputtering, vapor deposition, electrolytic deposition, and chemical deposition. Further, the pair of electrodes 20a, 20b can also be formed by applying an electrode paste and then baking it. Furthermore, the pair of electrodes 20a, 20b can also be formed by thermal spraying. The pair of electrodes 20a, 20b may be composed of a single layer, but may also be composed of a plurality of electrode layers having different compositions. A typical method for forming the pair of electrodes 20a, 20b will be described below.

First, an electrode slurry containing an electrode material, an organic binder, and a dispersion medium is prepared, and the first end face 12a or the second end face 12b of the honeycomb structure 10 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 10 is removed by blowing and wiping. The slurry can be then dried to form the pair of electrodes 20a, 20b on the first end face 12a or the second end face 12b of the honeycomb structure 10. The drying can be performed while heating the heater element to a temperature of about 120 to 600° C., for example. Although a series of steps of coating, slurry removal, and drying may be performed only once, the steps can be repeated multiple times to provide the pair of electrodes 20a, 20b having desired thicknesses.

The terminals 30 are then disposed at predetermined positions of the pair of electrodes 20a, 20b, and the pair of electrodes 20a, 20b and the terminals 30 are connected to each other. As a method of connecting the pair of electrodes 20a, 20b to the terminals, the method described above can be used. Also, when the intermediate material 50 is provided between the pair of electrodes 20a, 20b and the terminals 30, the intermediate material 50 may be arranged and connected to the predetermined position of the pair of electrodes 20a, 20b, and the terminals 30 may be then disposed at and connected to the predetermined positions of the intermediate material 50. As the method of connecting them, the method described above can be used.

It should be noted that the terminals 30 and the intermediate material 50 may be disposed after forming a functional material-containing layer 40 described below.

The functional material-containing layer 40 can be then formed on the surfaces of the partition walls 14 and the like of the heater element 1,2 thus obtained to provide the heater element with the functional material-containing layer.

Although the method for forming the functional material-containing layer 40 is not particularly limited, it can be formed, for example, by the following steps. The heater element 1,2 is immersed in a slurry containing a functional material, an organic binder, and a dispersion medium for a predetermined period of time, and an excess slurry on the end faces and the outer periphery of the honeycomb structure 10 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the functional material-containing layer 40 on the surfaces of the partition walls 14. The drying can be performed while heating the heater element 1, 2 to a temperature of about 120 to 600° ° C., for example. Although a series of steps of immersion, slurry removal, and drying may be performed only once, the steps can be repeated multiple times to provide the functional material-containing layer 40 having the desired thickness on the surfaces of the partition walls 14 and the like.

### (3. Vehicle Interior Purification System)

According to an embodiment of the present invention, a vehicle interior purification system including the heater element 1, 2 as described above is provided. The vehicle interior purification system can be suitably used for various vehicles such as automobiles.

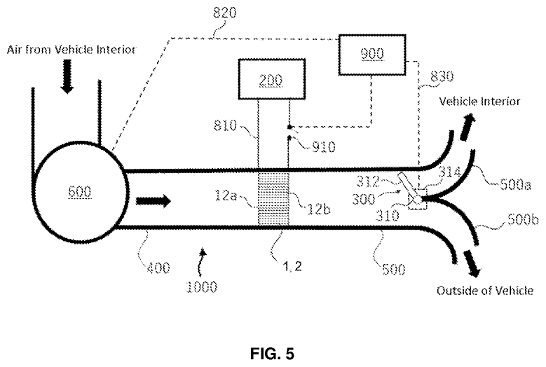

FIG. 5 is a schematic view illustrating a structure of a vehicle interior purification system according to an embodiment of the present invention.

As shown in FIG. 5, a vehicle interior purification system 1000 includes: at least one heater element 1, 2; a power supply 200 such as a battery for applying voltage to the heater element 1, 2; an inflow pipe 400 that communicates the vehicle interior with the first end face 12a of the heater element 1, 2; an outflow pipe 500 having a first path 500a communicating the second end face 12b of the heater element 1, 2 with the vehicle interior; and a ventilator 600 for causing air from the vehicle interior to flow into the first end face 12a of the heater element 1, 2 via the inflow pipe 400.

The outflow pipe 500 can have, in addition to the first path 500a, a second path 500b that communicates the second end face 12b of the heater element 1, 2 with the outside of the vehicle. Also, the outflow pipe 500 can have a switching valve 300 capable of switching the flow of the air flowing through the outflow pipe 500 between the first path 500a and the second path 500b.

The vehicle interior purification system 1000 can have operation modes: a first mode where the voltage applied from the power supply 200 is turned off, the switching valve 300 is switched such that the air flowing through the outflow pipe 500 passes through the first path 500a, and the ventilator 600 is turned on; and a second mode where the voltage applied from the power supply 200 is turned on, the switching valve 300 is switched so that the air flowing through the outflow pipe 500 passes through the second path 500b, and the ventilator 600 is turned on.

The vehicle interior purification system 1000 can include a control unit 900 that can execute the switching between the first mode and the second mode. For example, the control unit 900 may be configured to be able to alternately execute the first mode and the second mode. By repeating the switching between the first mode and the second mode in a constant cycle, the components to be removed can be stably discharged from the vehicle interior to the outside of the vehicle.

In the first mode, the air in the vehicle interior is purified. Specifically, the air from the vehicle interior flows in from the first end face 12a of the heater element 1, 2 through the inflow pipe 400, passes through the interior of the heater element 1, 2, and then flows out from the second end face 12b of the heater element 1, 2. The components to be removed from the air from the vehicle interior are removed such as by capturing them by the functional material while passing through the heater element 1, 2. The clean air flowing out from the second end face 12b of the heater element 1, 2 is returned to the vehicle interior through the first path 500a of the outflow pipe 500.

In the second mode, the functional material is regenerated. Specifically, the air from the vehicle interior flows in from the first end face 12a of the heater element 1, 2 through the inflow pipe 400, passes through the interior of the heater element 1, 2, and then flows out from the second end face 12b of the heater element 1, 2. The heater element 1, 2 generates the heat by electric conduction, whereby the functional material supported by the heater element 1, 2 is heated. Therefore, the components to be removed that are captured by the functional material are released from or allowed to react with the functional material.

In order to promote the releasing of the components to be removed that have been captured by the functional material, it is preferable to heat the functional material to a release temperature or higher depending on the type of the functional material. For example, when the adsorbent is used as the functional material, at least a part, preferably the whole, of the functional material is preferably heated to 70 to 150° C., and more preferably 80 to 140° C., and even more preferably 90 to 130° C. Further, it is desirable that the second mode is carried out for a period of time until the functional material is sufficiently regenerated. For example, when the adsorbent is used as the functional material, in the second mode, the functional material is preferably heated in the above temperature range for 1 to 10 minutes, and more preferably heated for 2 to 8 minutes, and even more preferably heated for 3 to 6 minutes, although it depends on the type of the functional material.

The air from the vehicle interior flows out from the second end face 12b of the heater element 1, 2 while accompanying the components to be removed that have released from the functional material during passing through the heater element 1, 2. The air containing the components to be removed that have flowed out from the second end face 12b of the heater element 1, 2 is discharged to the outside of the vehicle through the second path 500b of the outflow pipe 500.

The switching between turning-on and turning-off of the voltage applied to the heater element 1, 2 can be achieved, for example, by electrically connecting the power supply 200 to the pair of electrodes 20a, 20b of the heater element 1, 2 with electric wires 810, and operating a power switch 910 provided in the middle of the electric wire 810. For the operation of the power switch 910, the control unit 900 can be operated.

The switching between turning-on and turning-off of the ventilator 600 can be achieved, for example, by electrically connecting the control unit 900 to the ventilator 600 with an electric wire 820 or wirelessly, and operating a power switch (not shown) by the control unit 900. The ventilator 600 can also be configured such that an amount of ventilation can be changed by the control unit 900.

The switching valve 300 can be switched, for example, by electrically connecting the control unit 900 to the switching valve 300 with an electric wire 830 or wirelessly, and operating a switch (not shown) of the switching valve 300 by the control unit 900.

The switching valve 300 is not particularly limited as long as it is electrically driven and has a function of switching the flow path, but examples thereof include an electromagnetic valve and a motor-operated valve. In one embodiment, the switching valve 300 includes an opening/closing door 312 supported by a rotating shaft 310 and an actuator 314 such as a motor that rotates the rotating shaft 310. The actuator 314 is configured to be controllable by the control unit 900.

In the vehicle interior purification system 1000, the heater element 1, 2 is preferably arranged at a position close to the vehicle interior, in terms of stably ensuring the above functions. Therefore, from the viewpoint of preventing electric shock, the drive voltage is preferably 60 V or less. Since the honeycomb structure 10 used in the heater element 1, 2 has lower electrical resistance at room temperature, the honeycomb structure 10 can be heated at the lower drive voltage. The lower limit of the drive voltage is not particularly limited, but it may preferably be 10 V or more. If the drive voltage is less than 10 V, the current during heating of the honeycomb structure 10 is increased, so that the electric wire 810 should be thickened.

In the embodiment shown in FIG. 5, the ventilation 600 is installed on an upstream side of the heater element 1, 2. More particularly, the ventilator 600 is installed in the middle of the inflow pipe 400 that communicates the heater element 1, 2 with the vehicle interior, and the air that has passed through the ventilator 600 flows in so as to be pressed into the heater element 1, 2. Alternatively, the ventilator 600 may be installed on a downstream side of the heater element 1, 2. In this case, the ventilator 600 may be installed, for example, in the middle of the outflow pipe 500, and the air that has passed through the inflow pipe 400 flows in so as to be sucked into the heater element 1, 2.

### Examples

Hereinafter, the present invention will be described in more detail with reference to Examples, but the present invention is not limited to these Examples.

As ceramic raw materials, BaCO₃ powder, TiO₂ powder and La(NO₃)₃·6H₂O powder were prepared. These powders were weighed so as to have the predetermined composition after firing, and dry-mixed to obtain a mixed powder. The dry mixing was carried out for 30 minutes. Subsequently, 3 to 30 parts by weight of water, a binder, a plasticizer and a dispersant in total were added by a proper amount, based on 100 parts by mass of the obtained mixed powder, such that aceramic formed body having a relative density of 64.8% were obtained after extrusion, and then kneaded to obtain a green body. Methyl cellulose was used as the binder. Polyoxyalkylene alkyl ether was used as the plasticizer and the dispersant.

The obtained green body was then introduced into an extrusion molding machine and extruded using a predetermined die to obtain a honeycomb structure having the shape as shown below after the firing.
Shape of the cross section and each end face of the honeycomb structure orthogonal to the flow path direction: quadrangular;
Shape of the cross section of each cell orthogonal to the flow path direction: quadrangular;
Thickness of the partition wall t2: shown in Table 1;
Thickness of the outer peripheral wall: 0.127 mm;
Cell density: 85.3 cells/cm²;
Cell pitch: 1.08 mm;
Opening ratio of the cells: 0.55 to 0.80;
Cross-sectional area of the honeycomb structure orthogonal to the extending direction of the flow path direction: 4721 mm²;
Length of the honeycomb structure in the extending direction of the flow path: 11 mm;
Volume resistivity at 25° C. of the material forming the partition walls (and the outer peripheral wall): shown in Table 1; and
Curie point of the material forming the partition walls (and the outer peripheral wall): 120° C.

It should be noted that the volume resistivity of the partition walls was controlled by adjusting the mixing ratio of the raw materials and the firing conditions.

Subsequently, after dielectric drying and hot air drying of the obtained honeycomb formed body, it was degreased in an air atmosphere in a firing furnace (at 450° ° C. for 4 hours), and then fired in an air atmosphere to obtain a honeycomb structure. The firing was carried out by maintaining it at 950° C. for 1 hour, and then increasing the temperature to 1200° ° C. and maintaining it at 1200° ° C. for 1 hour, and then increasing the temperature at a temperature increasing rate of 200° C./hour to 1400° C. (the maximum temperature) and maintaining it at 1400° C. for 2 hours.

The pair of electrodes having the thickness t1 shown in Table 1 were then formed on both end faces (first end face and second end face) of the obtained honeycomb structure. The pair of electrodes were formed as follows. First, an electrode slurry containing aluminum (electrode material), ethyl cellulose, and diethylene glycol monobutyl ether (organic binder) was prepared, and one end face was coated with the slurry. Subsequently, after removing an excess electrode slurry on the outer periphery of the honeycomb structure by blowing and wiping, the electrode slurry was dried to form an electrode on the one end face. In the same way, an electrode was also formed on the other end face.

The honeycomb structure having the pair of electrodes formed thereon was immersed in a slurry containing zeolite (moisture absorbent) as a functional material, an organic binder, and water, and the slurry adhering to excess positions (outer periphery, etc.) was blown and wiped off, and then dried at a temperature of about 550° C. to form a functional material-containing layer at a predetermined position.

Subsequently, for samples Nos. 1 to 11, the terminals (Al) having the thickness shown in Table 1 were provided on the whole of the pair of electrodes on the outer peripheral wall and a part of the pair of electrodes on the partition walls. Also, for samples Nos. 12 to 19, the intermediate material (solder) was provided on the whole of the pair of electrodes on the outer peripheral wall and a part of the pair of electrodes on the partition walls, and the terminals (Al) having the thickness shown in Table 1 were provided on the intermediate material.

Each sample of the heater elements obtained as described above was subjected to the following evaluations. It should be noted that the volume resistivity of each of the partition walls, the pair of electrodes, and the terminals was measured at 25° C. in accordance with JIS K 6271:2008.

### <Dehumidification Performance>

A cycle of applying a voltage of 13.5 V for 3 minutes and applying no voltage for 3 minutes was repeated for 1 hour while passing the air with a relative humidity of 30% through each sample at a flow rate of 0.13 m/see, and an amount (g/h) of moisture that could be dehumidified was measured using a model gas device.

In this evaluation, a sample having an amount of moisture that could be dehumidified of 66 g/h or more is represented as A, a sample having an amount of moisture that could be dehumidified of less than 66 g/h and 50 g/h or more is represented as B, and sample having an amount of moisture that could be humidified of less than 50 g/h is represented as C.

### <Local Heat Generation>

A thermocouple was inserted into the center of the honeycomb structure, a voltage of 13.5 V was applied to each sample for 3 minutes, and the maximum temperature of the honeycomb structure was measured.

In this evaluation, a sample having the maximum temperature of less than 200° C. is represented as A, a sample having the maximum temperature of 200° C. or more and less than 240° C. is represented as B, and a sample having the maximum temperature of 240° C. or more is represented as C. It should be noted that the functional material is often deteriorated when the temperature exceeds 200° C., although it depends on the type.

### <Cracks>

A voltage of 13.5 V was applied to each sample for 3 minutes, and the presence or absence of cracks generated in the honeycomb structure was evaluated.

In this evaluation, a sample in which there were no visible cracks both visually and microscopically is represented as A, and a sample in which there were no visible cracks visually and microscopically is represented as B, and a sample in which there was/were a visible crack(s) is represented as C.

Table 1 shows the above evaluation results.

TABLE 1

| | Partition Walls | | Electrodes | | Terminais | | | | | | | | | |
|---|---|---|---|---|---|---|---|---|---|---|---|---|---|---|
| | | Volume | | Volume | | Volume | | | | | | | | |
| | | Resis- | | Resis- | | Resis- | | | | | De- | | | |
| | Thick- | tivity | Thick- | tivity | Thick- | tivity | | | | | humidi- | Local | | |
| | ness | ρ2 | ness | ρ1 | ness | ρ3 | | | | | fication | Heat | | |
| | t2 | [Ω · | t1 | [Ω · | t3 | [Ω · | (ρ1/t1)/ | (ρl/t1) | S1/ | S4/ | Perfor- | Gen- | | Sec- |
| Nos. | [mm] | cm] | [mm] | cm] | [mm] | cm] | (ρ2/t2) | (ρ3/t3) | S2 | S3 | mance | eration | Cracks | tions |
| 1 | 0.13 | 12 | 0.05 | 0.0001 | 1 | 0.00001 | 0.0000217 | 200 | 0.177 | — | A | A | A | Ex. |
| 2 | 0.20 | 5 | 0.02 | 0.001 | 1 | 0.00001 | 0.002 | 5000 | 0.177 | — | A | A | A | Ex. |
| 3 | 0.30 | 5 | 0.02 | 0.001 | 1 | 0.00001 | 0.003 | 5000 | 0.177 | — | A | A | A | Ex. |
| 4 | 0.30 | 5 | 0.01 | 0.001 | 1 | 0.00001 | 0.006 | 10000 | 0.177 | — | C | A | A | Comp. |
| 5 | 0.13 | 12 | 0.05 | 0.000001 | 0.2 | 0.0001 | 0.0000002 | 0.04 | 0,177 | — | A | A | A | Ex. |
| 6 | 0.13 | 12 | 0.10 | 0.000001 | 0.2 | 0.0001 | 0.0000001 | 0.02 | 0.177 | — | A | A | A | Ex. |
| 7 | 0.13 | 12 | 0.10 | 0.000001 | 0.1 | 0.0001 | 0.0000001 | 0.01 | 0.177 | — | A | C | C | Comp. |
| 8 | 0.13 | 12 | 0.05 | 0.0001 | 1 | 0.00001 | 0.0000217 | 200 | 0.422 | — | A | A | A | Ex. |
| 9 | 0.13 | 12 | 0.05 | 0.0001 | 1 | 0.00001 | 0.0000217 | 200 | 0.451 | — | B | A | A | Ex. |
| 10 | 0.13 | 12 | 0.05 | 0.0001 | 1 | 0.00001 | 0.0000217 | 200 | 0.010 | — | A | A | A | Ex. |
| 11 | 0.13 | 12 | 0.05 | 0.0001 | 1 | 0.00001 | 0.0000217 | 200 | 0.008 | — | A | B | B | Ex. |
| 12 | 0.13 | 12 | 0.05 | 0.0001 | 1 | 0.00001 | 0.0000217 | 200 | 0.177 | 0.50 | A | A | A | Ex. |
| 13 | 0.13 | 12 | 0.05 | 0.0001 | 1 | 0.00001 | 0.0000217 | 200 | 0.177 | 0.45 | B | B | A | Ex. |
| 14 | 0.13 | 12 | 0.05 | 0.0001 | 1 | 0.00001 | 0.0000217 | 200 | 0.177 | 2.00 | A | A | A | Ex. |
| 15 | 0.13 | 12 | 0.05 | 0.0001 | 1 | 0.00001 | 0.0000217 | 200 | 0.177 | 2.20 | B | A | A | Ex. |
| 16 | 0.13 | 30 | 0.05 | 0.0001 | 1 | 0.00001 | 0.0000087 | 200 | 0.177 | 1.00 | A | A | A | Ex. |
| 17 | 0.13 | 40 | 0.05 | 0.0001 | 1 | 0.00001 | 0.0000065 | 200 | 0,177 | 1.00 | B | A | A | Ex. |
| 18 | 0.30 | 12 | 0.05 | 0.0001 | 1 | 0.00001 | 0.0000500 | 200 | 0.177 | 1.00 | A | A | A | Ex. |
| 19 | 0.35 | 12 | 0.05 | 0.0001 | 1 | 0.00001 | 0.0000583 | 200 | 0.177 | 1.00 | B | A | A | Ex. |

As shown in Table 1, the heater elements according to Examples of the present invention in which the value of (ρ1/t1)/(ρ2/t2) was 0.003 or less and the value of (ρ1/t1)/(ρ3/t3) was 0.02 or more had good evaluation results for all of the dehumidification performance, the local heat generation, and the cracks.

On the other hand, the heater element (No. 4) according to Comparative Example in which the value of (ρ1/t1)/(ρ2/t2) was more than 0.003 had insufficient dehumidification performance. Also, the heater element (No. 7) according to Comparative Example in which the value of (ρ1/t1)/(ρ3/t3) was less than 0.02 resulted in the local heat generation.

As can be seen from the above results, according to the present invention, it is possible to provide a heater element that can sufficiently exert the performance of a functional material, and suppress deterioration of the functional material and damage to a honeycomb structure. Also, according to the present invention, it is possible to provide a vehicle interior purification system including such a heater element.

### DESCRIPTION OF REFERENCE NUMERALS

10 honeycomb structure
11 outer peripheral wall
12a first end face
12b second end face
13 cell
14 partition wall
20a, 20b electrode
30 terminal
40 functional material-containing layer
50 intermediate material
200 power supply
300 switching valve
310 rotation shaft
312 opening/closing door
314 actuator
400 inflow pipe
500 outflow pipe
500a first path
500b second path
600 ventilator
810, 820, 830 electric wire
900 control unit
910 power switch
1000 vehicle interior purification system

1. A heater element, comprising:
a honeycomb structure comprising an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property;
a pair of electrodes provided on the first end face and the second end face; and
terminals provided on at least a part of the pair of electrodes,
wherein (ρ1/t1)/(ρ2/t2) is 0.003 or less, and (ρ1/t1)/(ρ3/t3) is 0.02 or more, wherein ρ1 is a volume resistivity [Ω·cm] of the pair of electrodes, t1 is a thickness [mm] of the pair of electrodes, ρ2 is a volume resistivity [Ω·cm] of the partition walls, t2 is a thickness of the partition wall [mm], ρ3 is a volume resistivity [Ω·cm] of the terminals, and t3 is a thickness [mm] of the terminal.

2. The heater element according to claim 1, wherein S1/S2 is 0.010 or more, wherein S1 is an area [mm²] of surfaces where the terminals are in contact with the pair of electrodes, and S2 is an area [mm²] of the first end face or the second end face of the honeycomb structure.

3. The heater element according to claim 2, wherein the S1/S2 is 0.010 to 0.430.

4. The heater element according to claim 1, further comprising an intermediate material between the pair of electrodes and the terminals, wherein S4/S3 is 0.50 to 2.00, wherein S3 is an area [mm²] of surfaces where the terminals are in contact with the intermediate material, and S4 is an area [mm²] of a surface where the intermediate material is in contact with the pair of electrodes.

5. The heater element according to claim 1, wherein the material having the PTC property is made of a material comprising barium titanate as a main component, the material being substantially free of lead.

6. The heater element according to claim 1, wherein the material having the PTC property has a volume resistivity of 0.5 to 30 Ω·cm at 25° C.

7. The heater element according to claim 1, wherein the honeycomb structure has a thickness of the partition wall of 0.300 mm or less, a cell density of 100 cells/cm² or less, and a cell pitch of 1.0 mm or more.

8. The heater element according to claim 1, wherein the honeycomb structure has a thickness of the partition wall of 0.08 to 0.36 mm, a cell density of 2.54 to 140 cells/cm², and an opening ratio of the cells of 0.70 or more.

9. The heater element according to claim 1, comprising a functional material-containing layer on surfaces of the partition walls.

10. The heater element according to claim 9, wherein the functional material-containing layer comprises a functional material having a function of adsorbing one or more selected from water vapor, carbon dioxide, and volatile components.

11. The heater element according to claim 9, wherein the functional material-containing layer comprises a catalyst.

12. A vehicle interior purification system, comprising:
at least one heater element according to claim 1;
a power supply for applying a voltage to the heater element;
an inflow pipe communicating a vehicle interior with the first end face of the heater element;
an outflow pipe having a first path communicating the second end face of the heater element with the vehicle interior; and
a ventilator for causing an air from the vehicle interior to flow into the first end face of the heater element through the inflow pipe.

13. The vehicle interior purification system according to claim 12, wherein the outflow pipe has, in addition to the first path, a second path communicating the second end face of the heater element with the outside of a vehicle,
wherein the outflow pipe has a switching valve capable of switching the flow of the air flowing through the outflow pipe between the first path and the second path, and
wherein the vehicle interior purification system comprises a control unit capable of executing switching between:
a first mode wherein the voltage applied from the power supply is turned off, the switching valve is switched such that the air flowing through the outflow pipe passes through the first path, and the ventilator is turned on; and
a second mode wherein the voltage applied from the power supply is turned on, the switching valve is switched such that the air flowing through the outflow pipe passes through the second path, and the ventilator is turned on.
